(19) United States
(12) Patent Application Publication
(10) Pub. No.: US 2026/0167301 A1
(43) Pub. Date: Jun. 18, 2026

(54) Method for Operating a Pedal-Driven Vehicle and a Pedal-Driven Vehicle

(71) Applicant: Robert Bosch GmbH, Stuttgart (DE)

(72) Inventors: Sebastian Eberle, Tuebingen (DE); Daniel Gronbach, Stuttgart (DE); Merlin Martin Manewald, Reutlingen (DE)

(21) Appl. No.: 19/419,012

(22) Filed: Dec. 14, 2025

(30) Foreign Application Priority Data
Dec. 18, 2024 (DE) 10 2024 212 098.7

(51) Int. Cl. B62M 25/08; B62J 45/411; B62J 45/412; B62J 50/21

(52) U.S. Cl. CPC B62M 25/08; B62J 45/411; B62J 45/412; B62J 50/21

(57) ABSTRACT

A method is disclosed for operating a pedal-driven vehicle that includes at least one drive for providing a drive torque for propelling the pedal-driven vehicle, a gearshift for providing a variable transmission ratio, a control unit, and at least one detection unit. The method includes (i) detecting a drive torque provided by the drive, as well as a drive speed of the drive, in particular by way of a detection unit, and (ii) adjusting at least one operating parameter of the gearshift as a function of the drive torque and/or the drive speed and/or a drive power provided by the drive.

This application claims priority under 35 U.S.C. § 119 to patent application no. DE 10 2024 212 098.7, filed on Dec. 18, 2024 in Germany, the disclosure of which is incorporated herein by reference in its entirety.

### BACKGROUND

Pedal-driven vehicles, in particular electric bicycles, may be provided with an additional electric drive, which is intended to assist the rider in pedaling and thus to simplify the propulsion of the vehicle for the rider. The maximum drive power that can be provided by the drive results as a product from a maximum drive torque that can be provided by the drive at a maximum drive speed.

The drive speed is typically proportional to a pedal frequency of a rider of the pedal-driven vehicle at a crank mechanism. Thus, for a given rider pedal frequency, a maximum drive torque may be provided by the drive for the best possible rider relief.

However, if the drive speed corresponding to the rider pedal frequency is below the maximum drive speed, the drive will not reach its maximum drive power (maximum power) even if a maximum torque is provided. The rider of the pedal-driven vehicle thus receives only limited assistance from the drive in the sense that the assistance potential available by the drive is not fully utilized.

### SUMMARY

The present disclosure relates to a method for operating a pedal-driven vehicle, a pedal-driven vehicle, a computer program product, a computer-readable medium, and a data carrier signal. Further features and details of the disclosure will emerge from the description and the drawings. Features and details described in connection with the method according to the disclosure naturally also apply in connection with the pedal-driven vehicle according to the disclosure and/or in connection with the computer program product according to the disclosure and/or in connection with the computer-readable storage medium according to the disclosure and/or in connection with the data carrier signal according to the disclosure, and vice versa, so that there is or can always be mutual reference with regard to the disclosure of the individual aspects of the disclosure.

In particular, the disclosure presented serves to provide improved operation of a pedal-driven vehicle with respect to improved comfort of use of the pedal-driven vehicle, in particular improved rider assistance by way of a drive of the pedal-driven vehicle.

According to a first aspect, the present disclosure relates to a method for operating a pedal-driven vehicle, comprising at least one drive for providing a drive torque for propelling the pedal-driven vehicle, a gearshift for providing a variable transmission ratio, a control unit, and at least one detection unit, the method comprising:
detecting a drive torque provided by the drive, as well as a drive speed of the drive, in particular by way of a detection unit,
Optionally: determining a drive power provided by the drive from the drive torque and the drive speed of the drive, in particular by way of the control unit, and
adjusting at least one operating parameter of the gearshift as a function of the drive torque and/or the drive speed and/or a drive power provided by the drive.

It may preferably be provided that the stated method steps are carried out in the specified order. Additionally or alternatively, it is contemplated that at least individual method steps will be performed recurrently, in particular in a loop and/or, at least in part, simultaneously. Additionally or alternatively, the method can be configured as a computer-implemented method.

In other words, a method for operating a pedal-driven vehicle is proposed. The pedal-driven vehicle comprises a drive for providing a drive torque for propelling the pedal-driven vehicle. Preferably, the drive may be configured to assist a rider of the pedal-driven vehicle with propulsion. Furthermore, the pedal-driven vehicle comprises a gearshift for providing a variable transmission ratio, particularly in a drive train of the pedal-driven vehicle, a control unit and at least one detection unit.

According to the disclosure, it is provided that a drive torque provided by the drive of the pedal-driven vehicle, in particular by the detection unit, is detected. Detecting the drive torque can preferably be carried out by at least one torque sensor, in particular on a drive shaft of the drive. A drive speed of the drive is detected, in particular by the detection unit at which the drive torque is provided. Detecting the drive speed can preferably be carried out by at least one speed sensor, in particular on a drive shaft of the drive.

Preferably, it may be provided that the drive is operatively connected to a crank mechanism to introduce a rider torque of the pedal-driven vehicle, such that the drive speed is proportional to a rider pedaling frequency at the crank mechanism. The operative connection can be realized directly or, for example, via a gearing, in particular with a predetermined transmission ratio.

Preferably, it may be provided that a drive power provided by the drive is determined as a function of the drive speed and the drive torque. The drive power is derived from the product of the drive torque and drive speed.

According to the present disclosure, it is further provided that at least one operating parameter of the gearshift is adjusted as a function of the drive torque and/or the drive speed and/or a drive power provided by the drive.

An operating parameter of the gearshift may be, for example, a gear provided by the gearshift, in particular a transmission ratio provided by the gearshift. An operating parameter may additionally or alternatively also be a parameter according to which the shift behavior of the, in particular automatic, gearshift is directed, e.g. a target pedaling frequency. Additionally or alternatively, an operating parameter may also be a shift recommendation provided to the rider as part of a rider indication. A shift recommendation or rider indication to perform a gearshift, in particular manually, is intended to be understood as a recommendation to a rider that is characteristic of the rider shifting up (transmission ratio increase), shifting down (transmission ratio decrease), and/or maintaining the current gear.

Adjusting an operating parameter may preferably comprise changing or maintaining at least one operating parameter. In particular, adjusting at least one operating parameter may comprise a change in a transmission ratio or gear provided by the gearshift or gear and/or an output or retraction of a rider indication to perform a gear change, in particular manually (shift recommendation) and/or adjust a shift behavior, in particular a target pedaling frequency of the, in particular automatic or semi-automatic, gearshift.

The advantage of the method according to the disclosure is that the operation of the gearshift is adjusted in a targeted manner depending on the drive torque provided by the drive and the drive power provided. In this way, it is possible to increase the drive speed or rider pedaling frequency in a given riding situation at maximum drive torque in order to maximize the power provided by the drive or to bring it close to the maximum power, thereby relieving the rider as much as possible.

It may preferably be provided in relation to the present disclosure that adjusting at least one operating parameter of the gearshift comprises:
outputting a rider indication or a shift recommendation for, in particular manually, performing a gear change; and/or performing a gear change, in particular automatically, to reduce a transmission ratio provided by the gearshift, in particular by way of the control unit and/or gearshift and/or an output unit, if the drive torque reaches or exceeds an upper torque limit and/or the drive speed reaches or falls below a lower speed limit and/or the drive power reaches or falls below a lower power limit.

In other words, with respect to the present disclosure, it may be provided that, if the drive torque is greater than or equal to an upper torque limit and/or the drive speed, in particular at the same time, is less than or equal to a lower speed limit and/or the drive power, in particular at the same time, is less than or equal to a lower power limit, an indication is sent to the rider (rider indication) to perform a gear change, in particular manually, in order to reduce a transmission ratio provided by the gearshift (downshift).

Preferably, it may be provided that the driver indication is output when the drive torque is greater than or equal to the upper torque limit and, in particular at the same time, either the drive speed is less than or equal to the lower speed limit, or the drive power is less than or equal to the lower power limit,

An output of a rider indication for performing a gear change, in particular manually, to increase or reduce a transmission ratio provided by the gearshift and/or for adjusting a target pedaling frequency may preferably be performed by at least one output unit. In particular, a rider indication may be configured as a visual rider indication (e.g., a downward or upward arrow to symbolize an upshift or downshift). Additionally or alternatively, a rider indication may also be configured as an acoustic rider indication. The rider indication serves to make the rider aware that a corresponding gear change or an adjustment to the target pedaling frequency could be useful in order to prompt the rider to take appropriate action.

Additionally or alternatively, outputting the rider indication may comprise transmitting the indication to at least one mobile device, in particular a cell phone. For this purpose, at least one control unit may comprise at least one communication interface, in particular a mobile telephone interface or a Bluetooth interface. As a result, output units can be dispensed with for the pedal-driven vehicle, for example, since many riders also use their cell phone as a cycling computer. The rider indication may be indicated by the mobile device accordingly and so may be made accessible to a rider.

Additionally or alternatively, it may be provided that if the drive torque is greater than or equal to an upper torque limit and/or the drive speed, in particular at the same time is less than or equal to a lower speed limit and/or the drive power, in particular at the same time is less than or equal to a lower power limit, a gear change to reduce transmission ratios provided by the gearshift, in particular automatically and/or by the gearshift or the control unit, is performed. To perform a gear change, the gearshift may preferably be controlled by the control unit, and the gearshift may perform the gear change (e.g., by moving a derailleur of the gearshift). In this respect, the control unit and the gearshift may preferably perform a gear change, in particular an automatic gear change.

Preferably, it may be provided that the gear change is performed when the drive torque is greater than or equal to the upper torque limit, and, in particular at the same time, either the drive speed is less than or equal to the lower speed limit or the drive power is less than or equal to the lower power limit, Due to the direct relationship between drive torque, drive speed and drive power, it is equivalent to consider the drive speed or drive power in conjunction with the drive torque.

Reaching or exceeding the upper torque limit indicates that the drive torque provided by the drive is at or near its maximum. The power available by the drive is thus limited by the drive speed, which in turn is coupled to the rider's pedal frequency. A gear change to a gear with a reduced transmission ratio accelerates the rider pedal frequency in a given driving scenario. Thus, the speed at a crank mechanism of the pedal-driven vehicle increases and the drive speed increases to the same extent. Whereas previously the drive power was limited due to the too low speed, it can now be increased further towards a maximum power that can be provided by the drive. The lower speed limit may be selected such that the maximum drive power cannot be provided by the drive for a given maximum drive torque. Preferably, the lower power limit may be below the maximum power that can be provided by the drive. Thus, the increase in drive speed made by the downshift results in the possibility of increasing the drive power provided by the drive.

Preferably, the upper torque limit may correspond to a maximum torque that can be provided by the drive. A maximum torque of the drive can be, for example, 50 Nm or 85 Nm. Also, for example, the upper torque limit may correspond to at least 90%, or at least 95%, or at least 98% of a maximum torque that can be provided by the drive. Even such torques, which are only close to the maximum torque, indicate a high degree of utilization of the assistance that can be provided by the drive, so that it is advantageous to maximize the power that can be provided by the drive. In particular, the upper torque limit may be greater than a lower torque limit.

Preferably, the lower power limit may correspond to a maximum power that can be provided by the drive. Also, for example, the lower power limit may correspond to at least or exactly 90%, or at least or exactly 95%, or at least or exactly 98%, of a maximum torque or upper power limit that can be provided by the drive. A drive power of 98%, for example, could be considered to be a sufficient degree of utilization so that in this case further gear changes would be avoided, resulting in increased ride comfort for the rider as well as reduced wear on the gearshift. In particular, the lower power limit may be less than an upper power limit.

It may be provided in the context of the disclosure that outputting a rider indication to perform, in particular manually, and/or perform, in particular automatically, a gear change to reduce a transmission ratio provided by the gearshift only occurs when the drive torque reaches or exceeds the upper torque limit for a predetermined time period and/or the drive power reaches or falls below the lower power limit for an, in particular first, predetermined time period and/or the drive speed reaches or falls below a lower speed limit. This procedure can allow short-term fluctuations in drive torque or drive power to be disregarded and unnecessary gear changes to be avoided. In this way, a particularly comfortable and low-wear operation of the pedal-driven vehicle results. The predetermined time period may be configurable by a user, in particular via a mobile device, which can preferably have a communication connection to the control unit.

It may be provided that the method comprises:
Optionally: detecting and/or determining a rider pedaling frequency, in particular as a function of the drive speed,
detecting a rider torque, and
Optionally: determining a rider power as a function of the rider pedaling frequency and the rider torque,
   wherein outputting a rider indication to implement and/or perform a gear shift to reduce a transmission ratio provided by the gear shift occurs only when the rider torque reaches or exceeds an upper rider torque limit and/or the rider power reaches or exceeds an upper rider power limit.

This can ensure that a shift operation is only triggered or a shift recommendation is only output if the rider also needs actual assistance of the drive. In particular in situations in which only comparatively small rider power is introduced anyway, a shift operation or a corresponding recommendation can thus be omitted because there is no increased need for assistance for the rider.

Furthermore, it may be provided in the context of the present disclosure that the output of a rider indication to perform, in particular manually, and/or perform, in particular automatically, a gear change to reduce a transmission ratio provided by the gearshift only occurs if the drive speed reaches or falls below a lower speed limit. The lower speed limit may in particular be proportional to a lower pedaling frequency limit. In other words, in this case, gear changes are only recommended or performed if the rider pedaling frequency is outside their preferred pedaling frequency range (target pedaling frequency range), which is preferably set around a target pedaling frequency. In this way, a shift characteristic predetermined by the rider or factory may be prioritized more than maximizing the drive power or maximizing the drive power only takes place within the limits of the shift characteristic predetermined by the rider or factory. The rider's usual or desired shift behavior is thus respected and a different user experience than the expectations of the rider is avoided.

A target pedaling frequency should be understood as a pedaling frequency that is or can be pedaled by a rider of the pedal-driven vehicle, in particular in a given gear of the gearshift, without a gear change being carried out by the, in particular automatic or semi-automatic, gearshift. For example, the target pedaling frequency may be a pedaling frequency that is comfortable for a rider in many driving situations. If, on the other hand, the target pedaling frequency is exceeded by a certain pedaling frequency distance, i.e., if an upper pedaling frequency limit is reached or exceeded, a gear change to a higher gear, i.e. a gear with a higher transmission ratio can be carried out, in particular automatically, in order to lower the pedaling frequency to the target pedaling frequency. On the other hand, a gear change to a lower gear, i.e. a gear with a lower transmission ratio, can be carried out, in particular automatically, when the pedaling frequency falls below the target pedaling frequency by a certain pedaling frequency distance, i.e., reaches or falls below a lower pedaling frequency limit to increase the pedaling frequency to the target pedaling frequency.

In this respect, the target pedaling frequency represents an operating parameter of the gearshift, the change of which significantly affects the, in particular automatic, shift operation. The pedaling frequency can be detected, for example, via a speed sensor, in particular on a crank mechanism, of the pedal-driven vehicle.

In the present case, an upper pedaling frequency limit is to be understood as a pedaling frequency, upon reaching or exceeding which a gear change to increase a transmission ratio provided by the gearshift, in particular automatically, is triggered or performed. Preferably, an upper pedaling frequency limit may be greater than a target pedaling frequency and a lower pedaling frequency limit.

In the present case, a lower pedaling frequency limit is to be understood as a pedaling frequency, upon reaching or undershooting which a gear change to reduce a transmission ratio provided by the gearshift, in particular automatically, is triggered or performed. Preferably, a lower pedaling frequency limit may be less than a target pedaling frequency and an upper pedaling frequency limit.

In particular, the lower pedaling frequency limit, in conjunction with the upper pedaling frequency limit and with a target pedaling frequency, in particular located centrally between the upper and lower pedaling frequency limit, forms a target pedaling frequency range, specific for a given gear. A rider can pedal within this target pedaling frequency range without triggering a shift operation, in particular automatically. If the rider, however, leaves this frequency range with his pedaling frequency, a corresponding shift operation is triggered up or down. The shift operations are thus triggered in terms of hysteresis as a function of pedaling frequency limits positioned on both sides of the target pedaling frequency.

It may further be provided in relation to the present disclosure that the method comprises:
withdrawing an, in particular previously output, rider indication if an implementation of a shift recommendation characterized by the rider indication would lead to exceeding the upper torque limit by the driving torque, assuming a constant drive power.

This prevents the rider from performing a shift operation that would not maintain the power currently provided by the drive or would reduce the power that can be provided by the drive. In particular, a drive speed present after the shift recommendation has been implemented may be determined based on the transmission ratio of the new gear to be engaged.

With respect to the present disclosure, it is contemplated that adjusting at least one operating parameter of the gearshift comprises:
outputting a rider indication for performing a gear change, in particular manually, and/or performing a gear change, in particular automatically, to increase a transmission ratio provided by the gearshift, in particular by way of the control unit and/or gearshift and/or an output unit, if the drive torque reaches or falls below a lower torque limit and the drive power reaches or exceeds an upper power limit.

In other words, with respect to the present disclosure, it may be provided that, if the drive torque is less than or equal to a torque limit and/or the drive power, in particular at the same time, is greater than or equal to an upper power limit, an indication is sent to the rider (rider indication) to perform a gear change, in particular manually, in order to increase a transmission ratio provided by the gearshift (downshift).

Additionally or alternatively, it may be provided that if the drive torque is less than or equal to a lower torque limit and the drive power, in particular at the same time, is greater than or equal to an upper power limit, a gear change to increase transmission ratios provided by the gearshift, in particular automatically and/or by the gearshift or the control unit, is performed. To perform a gear change, the gearshift may preferably be controlled by the control unit accordingly, and the gearshift may perform the gear change (e.g., by moving a derailleur of the gearshift). In this respect, the control unit and the gearshift may preferably, in particular automatically, perform the gear change.

Reaching or falling below the lower torque limit while simultaneously maintaining high drive power indicates a reduction in drive torque due to high speed below the specified maximum drive power. A gear change to a gear with a reduced transmission ratio decelerates the rider pedal frequency in a given driving scenario. This reduces the speed of a crank mechanism of the pedal-driven vehicle and, proportionally, the drive speed. Accordingly, the drive torque may be adjusted at reduced drive speed or rider pedaling frequency to provide the rider with more comfortable assistance.

Preferably, the lower torque limit may correspond to a maximum torque that can be provided by the drive or be equal to the upper torque limit. Also, for example, the lower torque limit may correspond to at least or exactly 90%, or at least or exactly 95%, or at least or exactly 98% of the upper torque limit.

Preferably, the upper power limit may correspond to a maximum power that can be provided by the drive or be equal to the lower power limit.

It may be provided that the method comprises:
Optionally: detecting and/or determining a rider pedaling frequency, in particular as a function of the drive speed,
detecting a rider torque, and
Optionally: determining a rider power as a function of the rider pedaling frequency and the rider torque,
   wherein outputting a rider indication to implement and/or perform a gear shift to increase transmission ratio provided by the gear shift occurs only when the rider torque reaches or falls below a lower rider torque limit and/or the rider power reaches or exceeds a lower rider power limit.

It may be further provided that outputting a driver indication to perform, in particular manually, and/or perform, in particular automatically, a gear change to increase a transmission ratio provided by the gearshift only occurs when the drive torque reaches or falls below the lower torque limit for an, in particular second, predetermined time period and/or the drive power reaches or exceeds the upper power limit for a predetermined time period and/or the drive speed reaches or exceeds an upper speed limit. This procedure can allow short-term fluctuations in drive torque or drive power to be disregarded and unnecessary gear changes to be avoided. In this way, a particularly comfortable and low-wear operation of the pedal-driven vehicle results. The predetermined time period may be configurable by a user, in particular via a mobile device, which can preferably have a communication connection to the control unit.

Furthermore, it may be provided in the context of the present disclosure that the output of a rider indication to perform, in particular manually, and/or perform, in particular automatically, a gear change to increase a transmission ratio provided by the gearshift only occurs if the drive speed reaches or exceeds an upper speed limit. The upper speed limit may in particular be proportional to an upper pedaling frequency limit. In other words, in this case, gear changes are only recommended or performed if the rider pedaling frequency is outside their preferred pedaling frequency range. In this way, a shift characteristic predetermined by the rider or factory may be prioritized more than maximizing the drive power or maximizing the drive power only takes place within the limits of the shift characteristic predetermined by the rider or factory. The rider's usual or desired shift behavior is thus respected and a different user experience than the expectations of the rider is avoided.

It may be provided in the context of the disclosure that after a predetermined period of time has elapsed after the output of a rider indication, a gear change is performed to reduce or increase a transmission ratio provided by the gearshift, in particular automatically or by the gearshift and/or control unit, provided that no user action to prevent the gear change is performed within the predetermined time period. In other words, it may be provided that a rider of the pedal-driven vehicle is given the opportunity to prevent an, in particular automatic, gear change following the previous rider indication. If this is not done, the gear change is performed with the goal of increasing drive power or improving rider assistance. A suitable user action may be, for example, an actuation of a user interface of the pedal-driven vehicle, in particular the gearshift, in particular a shift lever or other control element, such as a button or the like.

It may further be provided in relation to the present disclosure that the method comprises:
detecting and/or determining a rider pedaling frequency, in particular as a function of the drive speed, in particular by the detection unit, and
outputting a rider indication for adjusting, in particular increasing, a target pedaling frequency or adjusting, in particular increasing, the target pedaling frequency when the drive torque reaches or exceeds an upper high torque limit and the drive power reaches or falls below a lower power limit and the rider pedaling frequency corresponds to a target pedaling frequency and/or is within a target pedaling frequency range, in particular by way of the control unit and/or output unit.

Detecting a rider pedaling frequency can occur, in particular by at least one speed sensor, by detecting the speed of a crank mechanism of the pedal-driven vehicle. Additionally or alternatively, the rider pedaling frequency may be determined as a function of the drive speed. Typically, there is a proportionality between the drive speed and the rider pedaling frequency, which is defined via the transmission ratio of a gear acting between the crank mechanism and the drive. By multiplying the drive speed by the reciprocal value of the transmission ratio, the speed at the crank mechanism and thus the rider pedaling frequency can be determined directly. Detecting a rider torque, in particular by a torque sensor, may be accomplished at a crank mechanism of the pedal-driven vehicle. Preferably, a rider power may be determined as a product of the rider pedaling frequency and the rider torque.

If a high, in particular maximum, drive torque is present, the power that can be provided by the drive can only be substantially increased via an increase in speed. However, this may conflict with a target pedaling frequency favored by the rider or a target pedaling frequency range centered around that target pedaling frequency, which is preferably defined by an upper and lower pedaling frequency limit. In this case, an indication may be issued to the rider indicating that, as part of the rider-specific requirements for the target pedaling frequency, the assistance power of the drive cannot be optimally exploited in order to alert the rider to this problem without ignoring the gearshift operating behavior defined by the rider.

It may further be provided in relation to the present disclosure that the method comprises:
detecting and/or determining a rider pedaling frequency, in particular as a function of the drive speed, in particular by the detection unit, and
outputting a rider indication for adjusting, in particular reducing, a target pedaling frequency or adjusting, in particular reducing, the target pedaling frequency when the drive torque reaches or falls below a lower torque limit and the drive power reaches or exceeds an upper power limit and the rider pedaling frequency corresponds to a target pedaling frequency and/or is within a target pedaling frequency range, in particular by way of the control unit and/or output unit.

If a reduced drive torque is present at maximum or almost maximum drive power, this indicates a reduction in the drive torque due to a high speed below the specified maximum power of the drive. In this case, an indication can be output to the rider, which signals that the drive torque of the drive is not optimally exploitable in the context of the rider-specific requirements for the target pedaling frequency in order to effect a corresponding adjustment.

It may be contemplated in the context of the disclosure that after a predetermined time period has elapsed following the output of a rider indication, a target pedaling frequency is adjusted, provided that no user action is taken to prevent the adjustment within the predetermined time period. In other words, it may be provided that a rider of the pedal-driven vehicle is given the opportunity to prevent an, in particular automatic, adjustment of the target pedaling frequency following the previous rider notification. If this is not done, the target pedaling frequency is adjusted. A suitable user action may be, for example, an actuation of a user interface of the pedal-driven vehicle, in particular the gearshift, in particular a shift lever or other control element, such as a button or the like.

Preferably, an adjustment to the target pedaling frequency includes a corresponding adjustment to the upper or lower pedaling frequency limit, such that the entire target pedaling frequency range is shifted up or down.

According to a second aspect, the present disclosure relates to a pedal-driven vehicle comprising a drive for providing drive torque for propelling the pedal-driven vehicle, a gear shift for providing a variable transmission ratio, a control unit and at least one detection unit. The pedal-driven vehicle is preferably configured to be operated according to a method according to the disclosure, in particular according to a method according to the first aspect of the disclosure. Preferably, the pedal-driven vehicle may be configured as a bicycle, preferably an electric cycle or pedelec. With respect to a pedal-driven vehicle, the same advantages result as described in relation to a method according to the disclosure. Preferably, the pedal-driven vehicle may comprise two wheels, in particular a front wheel and a rear wheel.

At least one drive may preferably be configured as an electric motor and/or arranged in a center motor assembly on the pedal-driven vehicle. Additionally or alternatively, a plurality of, in particular, similar or identical, drives can be comprised by the pedal-driven vehicle.

In particular, the gear shift may be provided to provide a variable transmission ratio, in particular in a drive train of the pedal-driven vehicle. The transmission ratio may be in particular characteristic of the number of revolutions of a drive wheel of the pedal-driven vehicle per revolution of a crank mechanism of the vehicle. In this respect, a high transmission ratio or high gear characterizes a comparatively high number of revolutions of the drive wheel per revolution of the crank mechanism. In contrast, a low transmission ratio or low gear characterizes a comparatively low number of revolutions of the drive wheel per revolution of the crank mechanism.

Preferably, the pedal-driven vehicle may comprise a crank mechanism. In particular, the crank mechanism allows a rider to be able or apply torque or power to propel the vehicle, via the crank mechanism.

In the present case, the gear shift may be configured as a derailleur gear system or a hub gear. Additionally or alternatively, it may be provided that the gear shift is configured as an automatic or at least partially automated gear shift. In particular, it can be provided that shift operations of the gearshift do not have to be triggered manually by a rider of the vehicle, but instead occur automatically based on one or more travel parameters. A travel parameter may be, for example, a speed of the pedal-driven vehicle, a pedaling frequency of a rider of the pedal-driven vehicle, and/or a rider torque introduced by a rider of the pedal-driven vehicle to propel the vehicle, or a power provided by a rider of the pedal-driven vehicle to propel the vehicle.

It may be provided that automatic or at least semi-automatic gearshift comprises at least one user interface, in particular at least one shift lever, for manually triggering a shift operation.

It may be provided in the context of the disclosure that at least one detection unit comprises at least one sensor. In particular, the detection unit may comprise at least one torque sensor for detecting a drive torque provided by the drive. Additionally or alternatively, the detection unit may comprise at least one speed sensor for detecting a drive speed of the drive and/or a speed of a crank mechanism of the pedal-driven vehicle or a rider pedaling frequency.

At least one control unit may be brought into communication and/or signal communication with a gearshift and/or detection unit and/or output unit and/or at least one drive, at least temporarily. Thus, data and/or control or regulating signals between the respective units may be exchanged.

At least one control unit and at least one detection unit may be configured as a common unit.

It may be provided in the context of the disclosure that at least one gearshift and/or control unit and/or detection unit and/or output unit comprises a data processing device. The data processing device may comprise at least one processor and/or working memory and/or non-volatile data store.

It may be provided that the pedal-driven vehicle, in particular the gearshift, comprises at least one output unit for outputting at least one rider indication, in particular for performing a gear change and/or for adjusting a target pedaling frequency. Preferably, at least one output unit may comprise a display for displaying a visual rider indication.

Additionally or alternatively, it may be provided that at least one control unit and/or output unit comprises at least one communication interface, in particular Bluetooth or mobile telephone interface, for communication with at least one mobile device. In this way, rider indications can be transmitted to the mobile device or parameter requirements such as a target pedaling frequency can also be transmitted from the mobile device to the control unit.

Additionally or alternatively, the output unit may comprise at least one output element for outputting an audible indication. Preferably, at least one output element may be configured as a speaker.

Additionally or alternatively, the output unit may comprise at least one actuator for output or for generating a haptic indication. For example, the actuator may be configured as a vibratory motor. At least one actuator can be arranged, for example, on a handle or handlebars of the pedal-driven vehicle. Such positioning has been shown to be particularly advantageous with respect to the transmission of haptic indications.

Additionally or alternatively, it may be provided that the output unit is configured to control a drive of the pedal-driven vehicle to output a haptic indication. For example, a drive torque provided by the drive at a crank mechanism of the pedal-driven vehicle may be altered or controlled such that this alteration is noticeable by a rider on the crank mechanism. In particular, the torque may be alternated between two values or increased and lowered again repeatedly. In this way, a haptic indication may be generated for the rider without use of additional actuators.

According to a third aspect, the present disclosure relates to a computer program product comprising instructions that cause a pedal-driven vehicle according to the disclosure, in particular a pedal-driven vehicle according to the second aspect of the disclosure, to perform a method according to the disclosure, in particular a method according to a first aspect of the disclosure. With respect to a computer program product according to the disclosure, the same advantages result in that they have already been described in relation to a method according to the disclosure and/or a pedal-driven vehicle according to the disclosure.

According to a fourth aspect, the present disclosure relates to a computer-readable medium, in particular a storage medium, wherein a computer program product according to the disclosure, in particular a computer program product according to the third aspect of the disclosure, is stored on the computer-readable medium. With respect to a computer-readable medium according to the disclosure, the same advantages result in that they have already been described in relation to a method according to the disclosure and/or a pedal-driven vehicle according to the disclosure and/or a computer program product according to the disclosure.

According to a fifth aspect, the present disclosure relates to a data carrier signal transmitting a computer program product according to the present disclosure, in particular a computer program product according to the third aspect of the disclosure. With respect to a data carrier signal according to the disclosure, the same advantages result in that they have already been described in relation to a method according to the disclosure and/or a pedal-driven vehicle according to the disclosure and/or a computer program product according to the disclosure and/or a computer-readable medium according to the disclosure.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination.

The figures schematically show the following:

FIG. 1 is a view of a method, and

FIG. 2 is a view of a pedal-driven vehicle.

### DETAILED DESCRIPTION

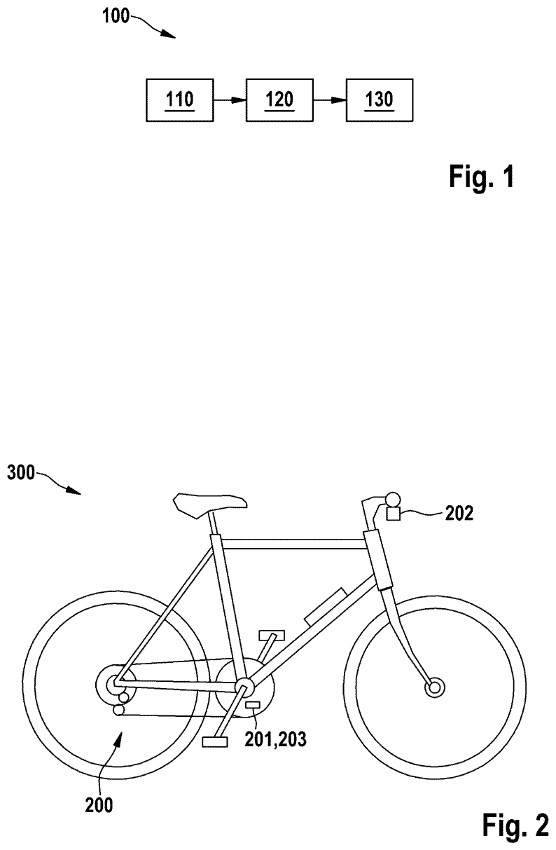

FIG. 1 illustrates a method 100 for operating a pedal-driven vehicle 200, comprising at least one drive 201 for providing a drive torque for propelling the pedal-driven vehicle 200, a gear shift 202 for providing a variable transmission ratio, a control unit 203, and at least one detection unit 204, the method 100 comprising:
detecting 110 a drive torque provided by the drive 201, as well as a drive speed of the drive, in particular by way of a detection unit 204,
optionally: determining 120 a drive power provided by the drive 201 from the drive torque and the drive speed of the drive 201, in particular by way of the control unit 203, and
adjusting 130 at least one operating parameter of the gearshift 202 as a function of the drive torque and/or the drive speed and/or a drive power provided by the drive 201.

Furthermore, FIG. 2 illustrates a view of a pedal-driven vehicle 200, comprising at least one drive 201 for providing a drive torque for propelling the pedal-driven vehicle 200, a gear shift 202 for providing a variable transmission ratio, a control unit 203 and at least one detection unit 204. In the present case, the control unit 203 as well as the detection unit 204 are configured as a common unit.

The pedal-driven vehicle 200 further comprises an output unit 205 for outputting a rider indication.

The drive 201 is operatively connected to a crank mechanism 206 via a gearing not shown at a predetermined transmission ratio to introduce a rider torque of the pedal-driven vehicle 200 so that the drive speed is proportional to a rider pedaling frequency and/or speed of the crank mechanism 206.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for operating a pedal-driven vehicle that includes at least one drive for providing a drive torque for propelling the pedal-driven vehicle, a gearshift for providing a variable transmission ratio, a control unit, and at least one detection unit, the method comprising:
detecting a drive torque provided by the drive, as well as a drive speed of the drive by way of the detection unit; and
adjusting at least one operating parameter of the gearshift as a function of the drive torque and/or the drive speed and/or a drive power provided by the drive.

2. The method according to claim 1, wherein adjusting at least one operating parameter of the gearshift comprises:
outputting a rider indication to implement and/or perform a gear change to reduce a transmission ratio provided by the gearshift when the drive torque reaches or exceeds an upper torque limit and the drive speed reaches or falls below a predetermined speed limit or the drive power reaches or falls below a lower power limit.

3. The method according to claim 2, wherein:
outputting a rider indication to implement and/or perform a gear change to reduce a transmission ratio provided by the gearshift only occurs when the drive torque reaches or falls below the upper torque limit for a predetermined time period and/or the drive power reaches or falls below the lower power limit for a predetermined time period.

4. The method according to claim 2, wherein:
outputting a rider indication to implement and/or perform a gear change to reduce a transmission ratio provided by the gearshift only occurs when the drive speed reaches or falls below a lower speed limit.

5. The method according to claim 1, wherein adjusting at least one operating parameter of the gearshift comprises:
outputting a rider indication to implement and/or perform a gear change to increase a transmission ratio provided by the gearshift by the control unit and/or the gearshift, when the drive torque reaches or falls below a lower drive limit and the drive power reaches or falls below an upper power limit.

6. The method according to claim 5, wherein:
outputting a rider indication to implement and/or perform a gear change to increase a transmission ratio provided by the gearshift only occurs when the drive torque reaches or falls below the lower torque limit for a predetermined time period and/or the drive power reaches or exceeds the upper power limit for a predetermined time period.

7. The method according to claim 5, wherein:
outputting a rider indication to implement and/or perform a gear change to increase a transmission ratio provided by the gearshift only occurs when the drive speed reaches or exceeds an upper speed limit.

8. The method according to claim 1, further comprising:
detecting and/or determining a rider pedaling frequency as a function of the drive speed; and
outputting a rider indication for increasing a target pedaling frequency and/or increasing the target pedaling frequency when the drive torque reaches or exceeds an upper high torque limit and the drive power reaches or falls below a lower power limit and the rider pedaling frequency corresponds to the target pedaling frequency and/or is within a target pedaling frequency range.

9. The method according to claim 1, further comprising:
detecting and/or determining a rider pedaling frequency as a function of the drive speed; and
outputting a rider indication for reducing a target pedaling frequency or reducing the target pedaling frequency when the drive torque reaches or falls below a lower torque limit and the drive power reaches or exceeds an upper power limit and the rider pedaling frequency corresponds to the target pedaling frequency and/or is within a target pedaling frequency range.

10. A pedal-driven vehicle, comprising:
at least one drive configured to provide a drive torque for propelling the pedal-driven vehicle;
a gearshift configured to provide a variable transmission ratio;
a control unit; and
at least one detection unit,
wherein the pedal-driven vehicle is configured to be operated according to the method of claim 1.

11. The pedal driven vehicle according to claim 10, further comprising at least one output unit configured to output at least one rider indication.

12. A computer program product comprising instructions that cause a pedal-driven vehicle to perform the method according to claim 1.

13. A computer-readable medium on which the computer program product according to claim 12 is stored.

14. A data carrier signal transmitting the computer program product according to claim 12.

15. The method according to claim 8, further comprising:
detecting and/or determining a rider pedaling frequency as a function of the drive speed; and
outputting a rider indication for reducing a target pedaling frequency or reducing the target pedaling frequency when the drive torque reaches or falls below a lower torque limit and the drive power reaches or exceeds an upper power limit and the rider pedaling frequency corresponds to the target pedaling frequency and/or is within a target pedaling frequency range.
